(19) United States
(12) Patent Application Publication
(10) Pub. No.: US 2005/0099745 A1
(43) Pub. Date: May 12, 2005

(54) ESD protection apparatus

(76) Inventors: Helmut Fischer, Oberhaching (DE); Jurgen Lindolf, Friedberg (DE); Michael Bernhard Sommer, Raubling (DE)

Correspondence Address: SLATER & MATSIL LLP, 17950 PRESTON ROAD, SUITE 1000, DALLAS, TX, 75252, US

(21) Appl. No.: 10/928,754

(22) Filed: Aug. 27, 2004

(30) Foreign Application Priority Data
Sep. 12, 2003 (DE) 103 42 305.2

(51) Int. Cl. H02H 9/00

(52) U.S. Cl. 361/56

(57) ABSTRACT

An ESD protection apparatus for limiting a voltage superimposed on an electric useful voltage to an allowable voltage, comprising a plurality of series-connected diodes. The diodes are forward-biased with reference to the useful voltage. Each individual forward-biased diode has a threshold voltage. The sum of the threshold voltages of the series-connected diodes corresponds to the allowable voltage.

### CROSS REFERENCE TO RELATED APPLICATION

This application claims priority from German Patent Application No. 10342305.2, which was filed on Sep. 12, 2003, and is incorporated herein by reference in its entirety.

### BACKGROUND OF THE INVENTION

1. Field of the Invention

The present invention relates to an ESD protection apparatus, and in particular to an ESD protection apparatus comprising a plurality of series-connected diodes.

2. Description of the Related Art

Electronic circuits react to over-voltages in a sensitive manner and thus have to be protected therefrom. A common cause of over-voltages is electrostatic discharges. In order to protect an electronic circuit attached to an external contact from ESD damage (ESD=electrostatic discharge), ESD protection apparatuses are employed, which switch at the occurrence of electrostatic voltage peaks and drain the electrostatic charges responsible for the over-voltage from the contact.

In particular in electronic circuits with low operating voltages, it is important for an ESD protection apparatus to have very low loss power in the normal operation. On the one hand, this is required not to corrupt the useful voltage, such as a signal voltage, and on the other hand to not unnecessarily increase the loss power of the entire electronic circuit.

Conventionally, ESD diodes are employed as protection apparatus. Such an ESD diode has a reverse voltage in reverse direction and a threshold or on-set voltage in flow direction. The threshold voltage is significantly lower than the reverse voltage. For the normal operation of the circuit, the diodes are reverse-biased. In the ESD case, with high voltages in reverse direction, an avalanche breakdown is triggered in the diode, and the charges responsible for the over-voltage are drained.

The avalanche breakdown occurs starting from voltages of about 7 V. Nowadays, electronic circuits have operating voltages significantly lower than the avalanche breakdown voltage of an ESD diode. The high voltages required for the avalanche breakdown are therefore frequently sufficient to cause considerable damage to the electronic circuit. This is the case in particular with MOS circuits with thin gate oxides.

According to the prior art, transistors, or a combination of a transistor and a diode, are also used as ESD protection apparatus. DE 100 02 241 A1 describes such a combination, in which a diode is employed in reverse direction with reference to a useful voltage.

### SUMMARY OF THE INVENTION

It is the object of the present invention to provide a flexible and reliable ESD protection apparatus.

In accordance with a first aspect, the present invention provides an ESD protection apparatus for limiting a voltage superimposed on an electric useful voltage to an allowable voltage, having a plurality of series-connected diodes forward-biased with reference to a useful voltage, wherein each forward-biased diode has a threshold voltage, and wherein the sum of the threshold voltages of the diodes correspond to the allowable voltage.

The invention is based on the finding that a series connection of forward-biased diodes may advantageously be employed as ESD protection apparatus.

The particular advantage of the present invention is that, in the ESD case, a forward-biased diode has a considerably lower threshold voltage than a reverse-biased diode.

The advantage of an ESD protection apparatus consisting of a cascade of diodes forward-biased in the ESD case thus is that electronic circuits may also be reliably protected from over-voltages lying only slightly above the useful voltage. Moreover, the inventive approach has high flexibility, since ESD protection circuits may be provided with application-specific switching thresholds and loss powers.

### BRIEF DESCRIPTION OF THE DRAWINGS

These and other objects and features of the present invention will become clear from the following description taken in conjunction with the accompanying drawings, in which:

FIG. 1 is a circuit diagram of an ESD protection apparatus according to the present invention; and

FIG. 2 is an illustration of a characteristic curve of the ESD protection apparatus according to the present invention.

### DESCRIPTION OF THE PREFERRED EMBODIMENTS

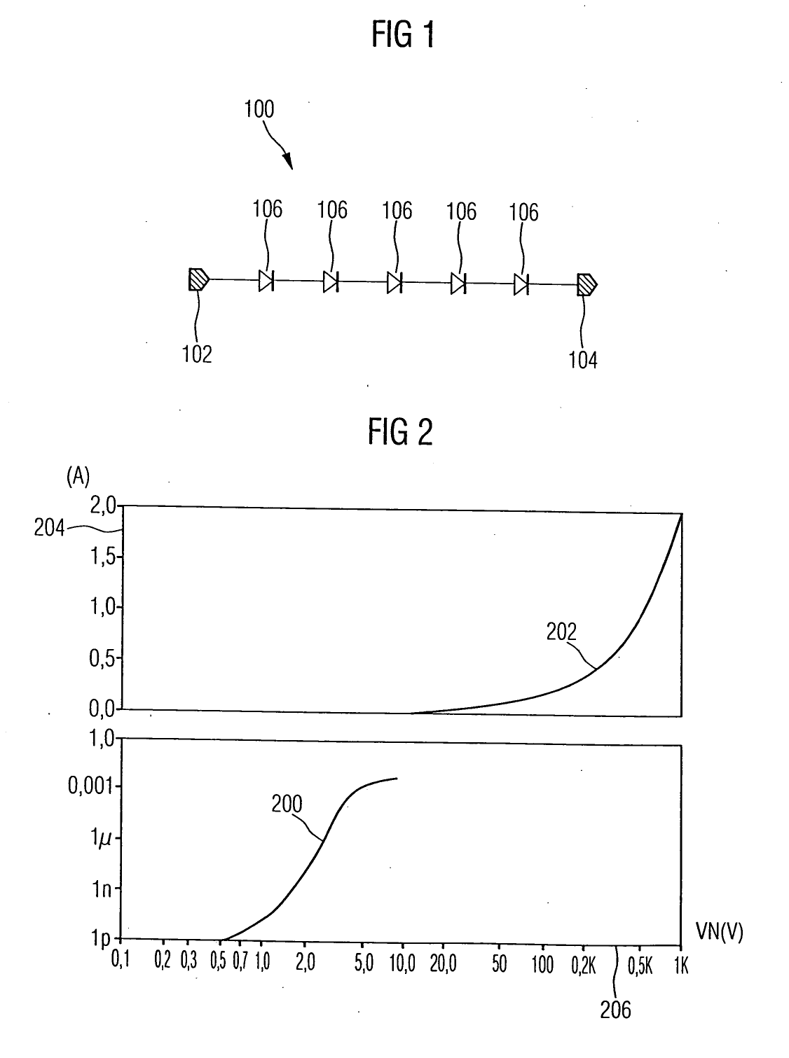

FIG. 1 shows a circuit diagram of an ESD protection apparatus 100 according to the present invention. The ESD protection apparatus 100 is arranged between a first contact 102 and a second contact 104.

In this embodiment, the ESD protection apparatus 100 has a series connection consisting of five diodes 106 and limits an over-voltage having the same polarity as a useful voltage of an electric circuit (not shown) to an allowable voltage.

In this embodiment, contact 102 is connected to the electronic circuit to be protected. In order to protect the electronic circuit from damage induced by over-voltages, contact 102 is connected to the second contact 104 via the ESD protection apparatus 100. The second contact 104 lies at an electric potential enabling drainage of charges, which induce an over-voltage on the first contact 102, via the ESD protection apparatus 100.

During the operation of the electronic circuit, a useful voltage is present at the first contact 102. The ESD protection apparatus 100 is arranged so that the diodes 106 are forward-biased with reference to the useful voltage. The number of series connected diodes 106 is chosen so that the sum of the threshold voltages of the series connected diodes 106 is greater than the useful voltage and smaller than or equal to the allowable voltage of the electronic circuit. The sum of the threshold voltages of the series connected diodes 106 thus corresponds to an allowable voltage to which an over-voltage present at the first contact 102 is limited.

Preferably, the diodes 106 are embodied as pn junctions, which are already present within the technological process. Thereby, no additional procedural steps are required for the ESD protection apparatus 100. pn junctions may be source/drain implants in the well implant belonging to a transistor type, source/drain diffusions in the well diffusion belonging to a transistor type, or a well implant or a n/p well diffusion in a p/n substrate.

FIG. 2 shows simulated characteristic curves 200, 202 of the ESD protection apparatus shown in FIG. 1. The characteristic curves 200, 202 show a current consumption 204 of the ESD protection apparatus in dependence on a present voltage 206. The characteristic curve 200 shows the current consumption 204 in a voltage range between 0.1 V and 10 V, and the characteristic curve 202 the current consumption 204 in a voltage range 206 from 10 V to 1 kV.

A threshold voltage of a diode is defined by a voltage value at which the diode has a desired internal resistance. The desired internal resistance may have a different value for different applications and thus define different threshold voltages of the diode. Accordingly, the inventive ESD protection apparatus is specified so that, at an allowable voltage, it has a desired internal resistance enabling degrading an over-voltage before damage to the electronic circuit arises. On the other hand, the ESD protection apparatus has to have a correspondingly high resistance at an operating voltage, to keep the loss power of the ESD protection apparatus as low as possible in the normal operation.

In the present embodiment, a single diode has a threshold voltage of 0.7 V. The operating voltage of the electronic circuit protected by the ESD protection apparatus against over-voltages lies at 2.7 V, and the allowable current consumption in the normal operation at 1 μA. From a known characteristic curve of an individual diode, the simulated characteristic curve 200, 202 of an ESD protection apparatus shown in FIG. 2, which has the demanded features, may be calculated. For the characteristic curve 200, it can be taken that the ESD protection apparatus consisting of five series-connected diodes at an operating voltage of 2.7 V has the specified current consumption of 1 μA. At an allowable voltage of 3.5 V, the ESD protection apparatus drains a current of 1 mA. The allowable voltage is a multiple of the simple threshold voltage of 0.7 V of an individual diode, but lies below the reverse voltage of an individual diode.

Although a preferred embodiment of the present invention has been explained above in greater detail, it is apparent that the present invention is not limited to this embodiment. In particular, the number of diodes, as well as the kinds of diodes, is not limited to the present embodiment, but is defined by the requirements for the ESD protection apparatus. Furthermore, the ESD protection apparatuses offer both protection against electrostatic charges and protection against any other form of over-voltage superimposed on a useful voltage of an electric circuit and having its polarity. The useful voltage may be a fixed voltage, such as an operating voltage, or a varying voltage in the form of an electric signal.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. An ESD protection apparatus for limiting a voltage superimposed on an electric useful voltage to an allowable voltage, comprising:
a plurality of series-connected diodes forward-biased with reference to the useful voltage, wherein each forward-biased diode has a threshold voltage, and wherein the sum of the threshold voltages of the diodes corresponds to the allowable voltage.

2. The ESD protection apparatus of claim 1, wherein the allowable voltage has the same polarity as the useful voltage.

3. The ESD protection apparatus of claim 1, wherein the number of series-connected diodes is chosen so that the allowable voltage is smaller than a reverse voltage of an individual diode.
